(19) United States
(12) Patent Application Publication
(10) Pub. No.: US 2006/0198776 A1
(43) Pub. Date: Sep. 7, 2006

(54) Mercury removal sorbent

(76) Inventors: Joseph B. Cross, Bartlesville, OK (US); Glenn W. Dodwell, Bartlesville, OK (US); Marvin M. Johnson, Bartlesville, OK (US); Jianhua Yao, Bartlesville, OK (US)

Correspondence Address: ConocoPhilips Company - I.P. Legal, PO BOX 2443, BARTLESVILLE, OK, 74005, US

(21) Appl. No.: 11/071,634

(22) Filed: Mar. 3, 2005

(51) Int. Cl. B01J 20/10; B01D 53/64

(52) U.S. Cl. 423/210; 502/407

(57) ABSTRACT

A sorbent composition comprising a vanadium-phosphorus-oxide material is disclosed. Methods of making and using the composition to remove heavy metals or heavy metal containing compounds from a fluid stream are also provided. Such methods are particularly useful in the removal of mercury and mercury compounds from flue gas streams produced from the combustion of hydrocarbon-containing materials such as coal and petroleum fuels.

The invention relates to a composition and method for removing heavy metal contaminants from fluid streams. In one aspect, the invention relates to a composition for sorbing heavy metal contaminants and a method of preparing such composition. In yet another aspect, the invention relates to a process for removing heavy metal contaminants, such as mercury and mercury compounds, from flue gas streams produced from the combustion of hydrocarbon-containing materials.

### BACKGROUND OF THE INVENTION

Heavy metals are released during the combustion process of many fossil fuels and/or waste materials. These heavy metals include, for example, arsenic, beryllium, lead, cadmium, chromium, nickel, zinc, mercury, and barium. Most of these heavy metals are toxic to humans and animals. In particular, elemental mercury and mercury compounds such as mercury chlorides are thought to compromise the health and mental acuity of young children and fetuses.

Furthermore, there is every indication that the amount of mercury, and possibly of other heavy metals, now legally allowed to be released by those combusting various fossil fuels and/or waste materials, including coal burning power plants and petroleum refineries, will be reduced by future legislation. While a variety of adsorbents are available for capture of heavy metals (in particular mercury), these adsorbents tend to have low capacities and are easily deactivated by other components in the gas stream, such as sulfur oxides. Thus, there exists a need for a material that removes elemental mercury from gas streams and has a high capacity for retaining mercury as a nonvolatile compound.

### SUMMARY OF THE INVENTION

It is an object of the present invention to provide an improved vanadium material with a high capacity for sorbing heavy metals and heavy metal compounds.

A further object of this invention is to provide a method for making an improved vanadium incorporated sorbent material by incorporating a vanadium-containing compound with a phosphorus compound.

Yet another object of this invention is to provide an improved vanadium material which when used in the removal of heavy metals results in the oxidation of the heavy metal to an oxidation state greater than zero.

Another object of this invention is to provide a process for removing heavy metals or heavy metal compounds from a fluid stream by contacting the fluid stream with an improved vanadium-phosphorus-oxide sorbent material.

It should be understood that the above-listed objects are only exemplary, and not all the objects listed above need be accomplished by the invention described and claimed herein.

In accordance with a first embodiment of the invention, the inventive composition comprises a porous sorbent material comprising calcined particles of a vanadium-phosphorus-oxide material, a silicate, and less than about 0.01% by weight of indium, antimony, and tantalum.

In accordance with a second embodiment of the invention, the inventive composition is prepared by a method comprising the steps of: (a) forming a mixture comprising at least one alcohol and a vanadium compound with vanadium in the +5 oxidation state; (b) reducing at least a portion of the vanadium to the +4 oxidation state; (c) adding a silicate compound and a phosphorus source to the mixture; (d) drying the mixture to form a dried vanadium-phosphorus-oxide material having less than about 0.01% by weight of indium, antimony, and tantalum; and (e) calcining the vanadium-phosphorus-oxide material.

In accordance with a third embodiment of the invention, the inventive composition can be used in the removal of at least one heavy metal or heavy metal containing compound from a fluid stream by a method comprising the step of: (a) contacting the fluid stream with a vanadium-phosphorus-oxide material for sorption of at least a portion of the at least one heavy metal or heavy metal containing compound.

In accordance with a fourth embodiment of the invention, the inventive composition can be used in the removal of at least one heavy metal or heavy metal containing compound from a flue gas stream produced by the combustion of a hydrocarbon-containing fuel, the method comprising the steps of: (a) contacting the flue gas stream with a first sorbent material comprising a vanadium-phosphorus-oxide material for sorbing at least a portion of the at least one heavy metal or heavy metal containing compound present in the flue gas stream; and

(b) contacting the flue gas with a second sorbent material different from the first sorbent material for sorbing at least a portion of the at least one heavy metal-containing compound not sorbed during step (a).

Other objects and advantages of the invention will become apparent from the detailed description and the appended claims.

### BRIEF DESCRIPTION OF THE FIGURES

A preferred embodiment of the present invention is described in detail below with reference to the attached figures, wherein:

FIG. 1 is a graph of mercury uptake versus mercury breakthrough for a vanadium/phosphorus sorbent compared to a conventional activated charcoal sorbent; and

FIG. 2 is a graph of the mercury removal efficiency for a vanadium/phosphorus sorbent.

### DETAILED DESCRIPTION OF THE INVENTION

Compositions according to the present invention generally comprise, consist of, or consist essentially of a porous vanadium-phosphorus-oxide material. As used herein, “vanadium-phosphorus-oxide material” is defined as any material comprising vanadium oxide and a phosphorus component, phosphorus oxide and a vanadium component, or vanadium oxide and phosphorus oxide materials, with the latter being particularly preferred. The vanadium and phosphorus substituents may be physically mixed or chemically bonded. An exemplary vanadium-phosphorus-oxide material is (VO₂)H₄P₂O₉. Nothing in this definition should be taken as excluding the presence of other components either intermingled, dispersed in, or bonded to the crystalline structure of the vanadium-phosphorus-oxide material. As explained in greater detail below, it is preferable for a silicate to be present in order to promote a crystalline structure for th sorbent material. Preferred silicates include those derived from a C1-C20 alkyl silicate such as tetraethylorthosilicate, tetramethylorthosilicate, and combinations thereof. The vanadium component is preferably in the +4 oxidation state and is derived from a vanadium compound, such as a vanadium oxide, more preferably V₂O₅. The phosphorus component is derived from a phosphorus compound including those selected from the group consisting of phosphoric acids, phosphorus oxides, phosphorus halides, phosphorus oxyhalides, phosphorus salts (such as ammonium metaphosphate), organophosphorus compounds, and combinations thereof. Most preferably, the phosphorus source is H₃PO₄.

Preferably, the sorbent material is substantially free of silicon promoters (other than the phosphorus source), especially indium, antimony, and tantalum. As used herein, the term “substantially free” is defined as meaning that the composition comprises less than about 0.01% by weight of the stated component, more preferably less than about 0.001% by weight, and most preferably less than about 0.0001% by weight. The most preferred embodiments of the present invention do not contain any indium, antimony, and tantalum.

The inventive composition is preferably calcined in order to remove any alkyl groups that may be present, especially alkyl groups present in the organic silicate. Sorbent compositions in accordance with the present invention generally comprise less than about 1% by weight of alkyl groups, more preferably less than about 0.5% by weight, and most preferably less than about 0.1% by weight.

The overall composition comprises from about 5-50% by weight vanadium. Unless otherwise specified, the phrase “by weight (element)” is defined as the elemental weight of the element present in the composition. More preferably, the composition comprises from about 7-40% by weight vanadium, and most preferably from about 10-30% by weight. The sorbent material comprises from about 1-20% by weight silicon, more preferably from about 2.5-15% by weight, and most preferably from about 5-10% by weight. The sorbent material also comprises from about 5-50% by weight phosphorus, more preferably from about 10-40% by weight, and most preferably from about 12-35% by weight. The weight ratio of vanadium to phosphorus in the vanadium-phosphorus-oxide material is between about 4:1 to 1:4, more preferably from about 3:1 to 1:3, and most preferably from about 2:1 to 1:2.

In order to maximize the sorptive capacity of the composition, the sorbent material preferably has a surface area of at least about 75 m²/g, more preferably at least about 100 m²/g, and most preferably at least about 150 m²/g. The sorbent material is generally in the form of discrete particles or agglomerations of particles having an average particle size of between about 0.01-20 mm, more preferably from about 0.1-10 mm, and most preferably from about 0.5-5 mm. The sorbant material may also be pelletized, formed into monoliths, or incorporated into a foam in order to render it suitable for a specific application.

In one embodiment, the sorbent material is formed by first creating a mixture comprising at least one alcohol and a vanadium compound, such as V₂O₅, with vanadium in the +5 oxidation state. Next, at least a portion of the vanadium is reduced to the +4 oxidation state by heating the mixture under reflux for about 1-2 hours. Then, a silicate compound and a phosphorus source are added to the mixture. Preferably, a first portion of the silicate compound is added and the mixture heated under reflux for about 1-3 hours, then a second portion of the silicate compound is added followed by the addition of the phosphorus source. The resulting mixture is then heated under reflux for about 6-12 hours. The solids remaining are separated and dried. Preferably, the solids are first air dried, and then dried under heat, generally at a temperature of between about 212-482° F. Finally, the dried sorbent material is calcined in air at a temperature of about 482-1112° F., more preferably from about 572-932° F., and most preferably from about 662-842° F.

The alcohol used in forming the sorbent material is preferably selected from the group consisting of C1-C20 alkyl, aryl, cycloalkyl, aralkyl, alkaryl alcohols and combinations thereof, with isobutyl alcohol and benzyl alcohol being particularly preferred.

As noted above, the calcination step results in the removal of alkyl groups present in the vanadium-phosphorus-oxide material. Preferably, calcination results in the removal of a sufficient alkyl groups so that the calcined sorbent comprises less than about 1% by weight of alkyl groups, more preferably less than about 0.5% by weight, and most preferably less than about 0.1% by weight.

Sorbent materials made in accordance with the present invention are particularly useful in the removal of heavy metals and heavy metal containing compounds from fluid streams, especially flue gas streams produced by the combustion of hydrocarbon-containing materials such as coal and petroleum fuels. As noted above, such fluid streams are often contaminated with at least one heavy metal or compound containing a heavy metal selected from the group consisting of arsenic, beryllium, lead, cadmium, chromium, nickel, zinc, mercury, and barium. In one aspect, methods of removing heavy metal and heavy metal containing compounds from fluid streams comprise providing a sorbent composition according to the present invention and contacting the stream with the inventive sorbent.

Flue gas, such as that created by the combustion of hydrocarbon-containing compounds, generally comprises at least about 10% by weight N₂, more preferably at least about 50% by weight, and most preferably between about 75-90% by weight. Flue gas also generally comprises less than about 10% by weight of uncombusted hydrocarbons, more preferably less than about 5% by weight, and most preferably less than about 1% by weight. In a particularly preferred application, the flue gas will have already been treated for removal of NOₓ and SOₓ prior to any heavy metal removal process as the presence of high levels of NOₓ and SOₓ compounds may lead to fouling of the heavy metal removal sorbents. Preferably, the flue gas comprises less than about 800 ppm of SOₓ compounds such as SO₂, more preferably less than about 500 ppm, and most preferably less than about 400 ppm. Also, the flue gas preferably comprises less than about 400 ppm NOₓ such as NO and NO₂, more preferably less than about 250 ppm, and most preferably less than about 150 ppm. Flue gas may also comprise between about 2.5-10% by weight O₂, between about 1-5% by weight CO₂, and between about 5-20% by weight H₂₀.

Preferably, the pressure drop associated with the contacting step should not exceed more than about 20 psia. More preferably, the pressure drop in the fluid stream is less than about 10 psia, and most preferably less than about 5 psia. Typically, flue gas streams do not flow under high pressures. Therefore, if the pressure drop is too great, back pressure is created and can affect the combustion process by which the flue gas is created. The arrangement of the sorbent material in the vessel in which contacting occurs can assist in minimizing this pressure drop. Preferably, the sorbent material comprises finely divided particles that are suspended in the fluid stream during the contacting step. Alternatively, the sorbent material may be positioned in a fluidized bed, placed in a packed bed column, formed into monoliths, or incorporated into a foam. With the latter arrangements, pressure drop becomes much more of a concern and may require the use of fans or other equipment to increase the pressure of the flue gas stream.

The fluid stream containing the heavy metal contaminant preferably has a temperature of between about 50-400° F. during the contacting step, more preferably between about 100-375° F., and most preferably between about 200-350° F. The temperature of the fluid stream at the contacting stage is in part affected by upstream processes such as particulate removal systems (i.e., cyclones), other contaminant removal systems, heat exchange systems, etc.

The contacting step results in the sorption of at least about 80% by weight of the heavy metals contained in the fluid stream, more preferably at least about 90% by weight, even more preferably at least about 95% by weight, and most preferably at least about 98% by weight. As previously stated, the vanadium-phosphorus-oxide material exhibits a high capacity for sorbing heavy metals and heavy metal containing compounds. Preferably, the vanadium-phosphorus-oxide material is capable of sorbing at least about 1 atom of a heavy metal per every 5 atoms of vanadium. More preferably, the ratio of heavy metal atoms sorbed to vanadium atoms is at least about 1:3, and most preferably 1:1.

The sorbent material also exhibits the ability to oxidize the elemental heavy metal into a heavy metal containing compound such as a heavy metal oxide or chloride. Using mercury as an example, the sorbent material oxidizes mercury into various oxidized species such as Hg⁺¹, Hg⁺², or mercury compounds such as HgO, HgCl, and HgCl₂. At times, due to system inefficiencies or sorbent saturation, some of these heavy metal containing compounds may desorb or break free from the sorbent material. In that case, it can be particularly useful to employ a downstream heavy metal compound removal system in conjunction with the above-described sorbent system. In the heavy metal compound removal system, the gaseous product stream is contacted with a separate adsorbent in an adsorption zone. The adsorbent can be any adsorbent capable of adsorbing a heavy metal; however, preferred materials for removing the heavy metal compounds include those having a hydrophobic surface with pore openings of less than about 10 Å, and high pore volumes. More preferably, the adsorbent comprises, consists of or consists essentially of a material selected from the group consisting of a zeolite, amorphous carbon and combinations thereof. The amorphous carbon can be an activated carbon and/or activated charcoal. Exemplary zeolites include those with 8-12 member ring openings, and particularly ZSM-5 zeolite. Furthermore, the material may be in the form of granules, pellets, monoliths, powders that are collected on filters, or combinations thereof. A treated gaseous product stream is withdrawn from the adsorption zone and contains less than about 20 weight %, preferably less than about 10 weight %, and more preferably less that about 5 weight % of the heavy metal in the gaseous feed stream.

The heavy metal compound removal system may be contained in a separate downstream vessel from the vanadium-phosphorus-oxide sorbent, or can be situated along with the vanadium-phosphorus-oxide sorbent in a multiple stage contacting vessel so that the flue gas first contacts the vanadium-phosphorus-oxide sorbent followed by the heavy metal compound removal sorbent.

While the vanadium-phosphorus-oxide sorbent material exhibits a relatively high capacity for sorbing heavy metals and heavy metal containing compounds, its cost is relatively higher than the cost for conventional heavy metal compound sorbent materials such as zeolite. Therefore, from an economic standpoint, it may be desirable to employ a relatively small amount of the vanadium-phosphorus-oxide sorbent compared to the conventional sorbent material. Once the sorptive capacity of the vanadium-phosphorus-oxide sorbent has sufficiently diminished, it will not be able to sorb sufficient quantities of the heavy metal containing compounds formed by the catalytic action of the vanadium-phosphorus-oxide sorbent. These heavy metal containing compounds may then be sorbed by the lesser expensive heavy metal compound sorbent material located downstream from the vanadium-phosphorus-oxide sorbent.

The heavy metal compound removal system preferably results in the sorption of at least about 80% by weight of the heavy metal containing compounds that break through the vanadium-phosphorus-oxide sorbent material, more preferably at least about 90% by weight, and most preferably at least about 95% by weight.

In addition to the vanadium-phosphorus-oxide sorbent material becoming saturated, the overall sorptive efficiency may be effected by the presence of NOₓ and SOₓ compounds present in the flue gas. For example, SO₂ contained in the flue gas stream may be oxidized to SO₃ and then converted to H₂SO₄ in the presence of water. The H₂SO₄ then may fill the pores of the vanadium-phosphorus-oxide sorbent thereby decreasing the sorptive capacity thereof and blocking active catalyst sites. Therefore, it is preferable to employ an upstream NOₓ and SOₓ removal process in order to avoid fouling of the vanadium-phosphorus-oxide sorbent material. Any conventional NOₓ and SOₓ removal process would be suitable for use with the present invention. The NOₓ and SOₓ removal process should preferably remove at least about 50% by weight of all NOₓ and SOₓ present in the flue gas stream. It is preferable for the flue gas stream immediately prior to contact with the vanadium-phosphorus-oxide sorbent to comprise less than about 400 ppm NOₓ, more preferably less than about 250 ppm, and most preferably less than about 150 ppm. Likewise, it is preferable for the flue gas stream immediately prior to contact with the vanadium-phosphorus-oxide sorbent to comprise less than about 800 ppm SOₓ, more preferably less than about 500 ppm, and most preferably less than about 400 ppm.

The heavy metal compound removal system is capable of performing effectively even at high flue gas flow rates (i.e., >10,000 gas hourly space velocity). The sorbent material used in the heavy metal compound removal system may be placed in a fluidized or packed bed vessel, however, as with the vanadium-phosphorus-oxide sorbent material system above, the pressure drop of the flue gas stream should be minimized to avoid requiring the use of additional equipment to compensate for the pressure drop.

### EXAMPLE

The following example illustrates preferred sorbent materials and methods of making the same in accordance with the present invention. This example should not be taken as limiting the scope of the present invention in any way.

In this example, a sorbent material according to the present invention was prepared by heating 50 g of vanadium oxide (V₂O₅) in a mixture of 500 ml of isobutyl alcohol and 50 ml of benzyl alcohol under reflux. The mixture was heated under reflux for about 1 hour to bring about the reduction of the V₂O₅. Next, 15 g of tetraethyl orthosilicate (Si(OEt)₄) was added, followed by the addition of 73 g of 85% H₃PO₄. The resulting mixture, having a dark green appearance, was heated at reflux overnight to give a light-blue slurry. The slurry was cooled and the solid portion filtered off and dried, first at 248° F. and then at 392° F. The resultant green-gray solid was then calcined at 752° F. in air.

The sorbent material was tested for efficacy in removing elemental mercury entrained in an air stream at a concentration of approximately 1000 μg/m³ (ppb w/v). Portions of the sorbent were placed in a fixed bed reactor, the temperature of which was held constant at 302° F. The air flow rate through the fixed bed reactor was set at a gas hourly space velocity of approximately 10,000. The air stream entering and exiting the fixed bed reactor was periodically analyzed using a Jerome Mercury Analyzer.

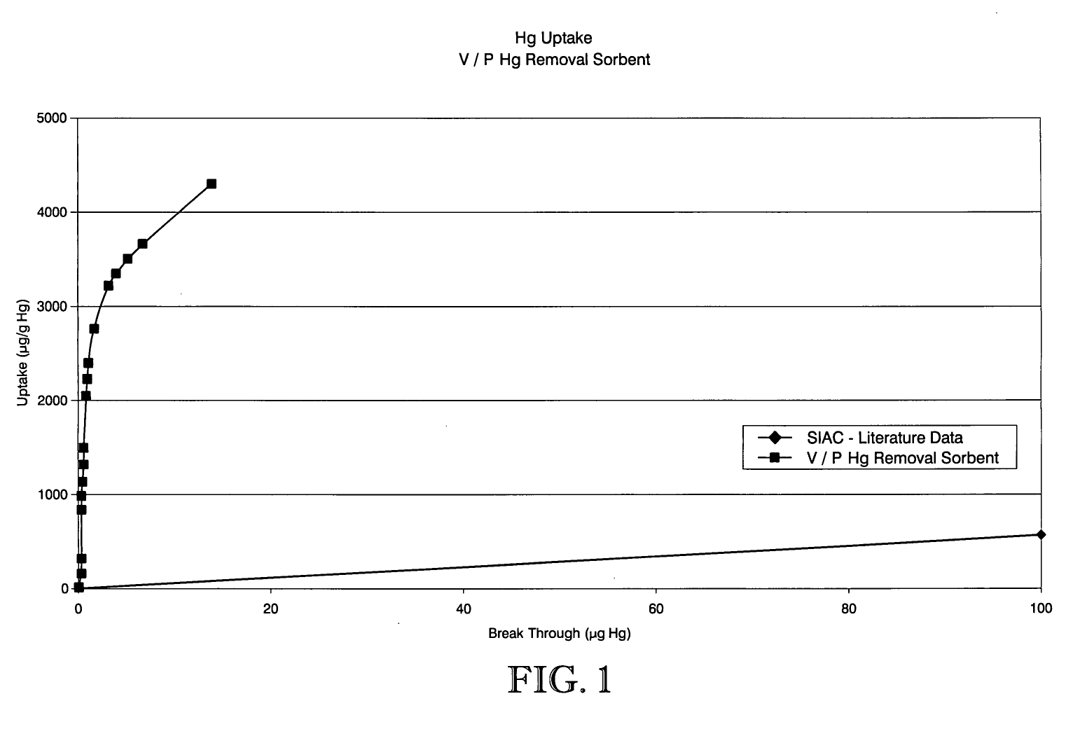

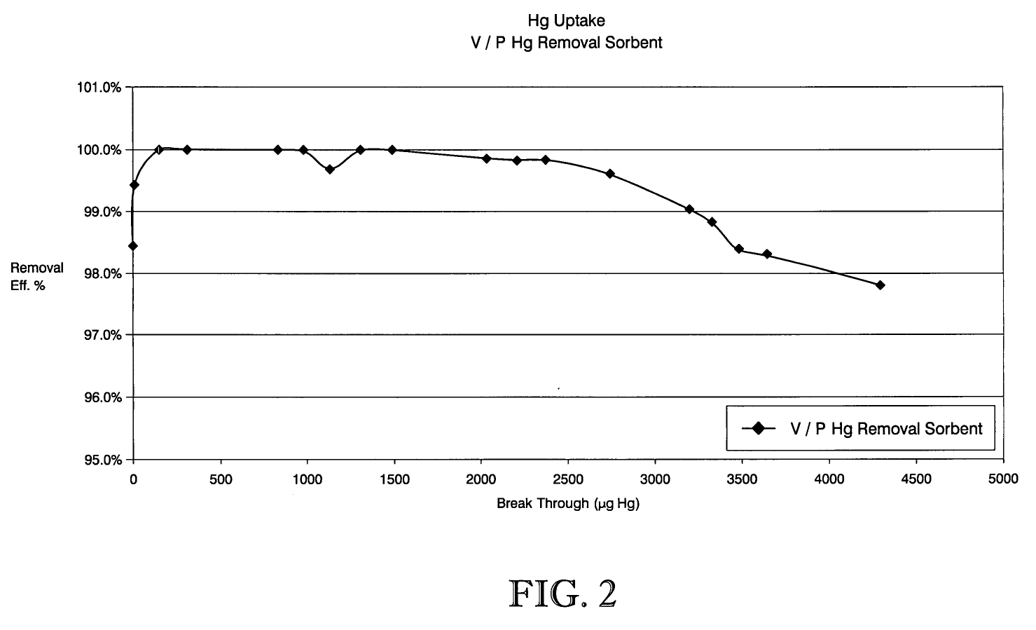

FIG. 1 shows the mercury uptake versus the mercury breakthrough of the sorbent material tested. For purposes of comparison, literature data for sulfur impregnated activated charcoal (SIAC), a conventional sorbent for this application, is also shown. The vanadium/phosphorus material demonstrated excellent capacity for sequestering mercury when compared with the SIAC literature data. FIG. 2 further demonstrates the effectiveness of the sorbent material in removing mercury from the air stream in terms of efficiency of the sorbent versus mercury uptake. The sorbent material exhibited superior efficiency in sequestering the mercury. Even for prolonged exposure times, the sorbent exhibited greater than 97% efficiency in mercury removal.

That which is claimed is:

1. A porous sorbent material comprising calcined particles of a vanadium-phosphorus-oxide material, a silicate, and less than about 0.01% by weight of indium, antimony, and tantalum.

2. A composition in accordance with claim 1 wherein the weight ratio of vanadium to phosphorus in said vanadium-phosphorus-oxide material is between about 4:1 to 1:4.

3. A composition in accordance with claim 1 wherein said sorbent material comprises less than about 1% by weight of alkyl groups.

4. A composition in accordance with claim 1 wherein said particles have an average particle size of between about 0.01-20 mm.

5. A composition in accordance with claim 1 wherein said material comprises from about 5-50% by weight vanadium.

6. A composition in accordance with claim 1 wherein said sorbent material has a surface area of at least about 75 m²/g.

7. A composition in accordance with claim 1 wherein said sorbent material comprises from about 1-20% by weight silicon.

8. A composition in accordance with claim 1 wherein said sorbent material comprises from about 5-50% by weight phosphorus.

9. A composition in accordance with claim 1 wherein said sorbent material comprises less than about 0.001% by weight of indium, antimony, and tantalum.

10. A method for forming a sorbent material comprising:
(a) forming a mixture comprising at least one alcohol and a vanadium compound with vanadium in the +5 oxidation state;
(b) reducing at least a portion of said vanadium to the +4 oxidation state;
(c) adding a silicate compound and a phosphorus source to said mixture;
(d) drying said mixture to form a dried vanadium-phosphorus-oxide material having less than about 0.01% by weight of indium, antimony, and tantalum; and
(e) calcining said vanadium-phosphorus-oxide material.

11. A method in accordance with claim 10 wherein said vanadium compound comprises a vanadium oxide.

12. A method in accordance with claim 11 wherein said vanadium oxide compound is V₂O₅.

13. A method in accordance with claim 10 wherein said at least one alcohol is selected from the group consisting of C1-C20 alkyl, aryl, cycloalkyl, aralkyl, alkaryl alcohols and combinations thereof.

14. A method in accordance with claim 13 wherein said at least one alcohol is selected from the group consisting of isobutyl alcohol, benzyl alcohol, and combinations thereof.

15. A method in accordance with claim 10 wherein said silicate compound is a C1-C20 alkyl silicate.

16. A method in accordance with claim 15 wherein said silicate compound is selected from the group consisting of tetraethylorthosilicate, tetramethylorthosilicate, and combinations thereof.

17. A method in accordance with claim 10 wherein said phosphorus source is selected from the group consisting of phosphoric acids, phosphorus oxides, phosphorus halides, phosphorus oxyhalides, phosphorus salts, organophosphorus compounds, and combinations thereof.

18. A method in accordance with claim 17 wherein said phosphorus source is H₃PO₄.

19. A method in accordance with claim 10 wherein said calcining step includes heating said vanadium-phosphorus-oxide material to a temperature of between about 482-1112° F.

20. A method in accordance with claim 10 wherein said calcination step results in the removal of alkyl groups present in said vanadium-phosphorus-oxide material thereby forming a vanadium-phosphorus-oxide material comprising less than about 1% by weight alkyl groups.

21. A method in accordance with claim 10 wherein said calcined vanadium-phosphorus-oxide material comprises from about 5-50% by weight vanadium.

22. A method in accordance with claim 10 wherein said calcined vanadium-phosphorus-oxide material comprises from about 1-20% by weight silicon.

23. A method in accordance with claim 10 wherein said calcined vanadium-phosphorus-oxide material comprises from about 5-50% by weight phosphorus.

24. A method of removing at least one heavy metal or heavy metal containing compound from a fluid stream, said method comprising the step of:
(a) contacting said fluid stream with a vanadium-phosphorus-oxide material for sorption of at least a portion of said at least one heavy metal or heavy metal containing compound.

25. A method in accordance with claim 24 wherein said vanadium-phosphorus-oxide material oxidizes said heavy metal into an oxidized heavy metal species or heavy metal containing compound.

26. A method in accordance with claim 24 wherein said vanadium-phosphorus-oxide material further comprises from about 1-20% by weight silicon.

27. A method in accordance with claim 24 wherein said contacting step results in a pressure drop in said fluid stream of less than about 20 psia.

28. A method in accordance with claim 27 wherein said contacting step results in a pressure drop in said fluid stream of less than about 10 psia.

29. A method in accordance with claim 24 wherein said fluid stream has a temperature between about 50-400° F. during said contacting step.

30. A method in accordance with claim 24 wherein said fluid stream comprises at least one heavy metal or compound containing a heavy metal selected from the group consisting of arsenic, beryllium, lead, cadmium, chromium, nickel, zinc, mercury, and barium.

31. A method in accordance with claim 30 wherein said at least one heavy metal is mercury.

32. A method in accordance with claim 24 wherein said vanadium-phosphorus-oxide material comprises finely divided particles that are suspended in said fluid stream during said contacting step.

33. A method in accordance with claim 24 wherein said contacting step results in the sorption of at least about 80% by weight of the at least one heavy metal contained in said fluid stream.

34. A method in accordance with claim 24 wherein said vanadium-phosphorus-oxide material is capable of sorbing at least about 1 atom of said heavy metal per every 5 atoms of vanadium.

35. A method in accordance with claim 24 wherein said vanadium-phosphorus-oxide material comprises from about 5-50% by weight vanadium.

36. A method in accordance with claim 24 wherein said vanadium-phosphorus-oxide material comprises less than about 1% by weight alkyl groups.

37. A process for the removal of at least one heavy metal or heavy metal containing compound from a flue gas stream produced by the combustion of a hydrocarbon-containing fuel comprising the steps of:
(a) contacting said flue gas stream with a first sorbent material comprising a vanadium-phosphorus-oxide material for sorbing at least a portion of said at least one heavy metal or heavy metal containing compound present in said flue gas stream; and
(b) contacting said flue gas with a second sorbent material different from said first sorbent material for sorbing at least a portion of said at least one heavy metal-containing compound not sorbed during step (a).

38. A process as recited in claim 37 wherein said second sorbent material comprises a material selected from the group consisting of porous zeolite materials, amorphous carbons, and combinations thereof.

39. A process as recited in claim 38 wherein said amorphous carbons are selected from the group consisting of activated charcoal, activated carbon, and combinations thereof.

40. A process as recited in claim 38 wherein said porous zeolite material comprises ZSM-5 zeolite.

41. A process as recited in claim 37 wherein said flue gas stream comprises at least one heavy metal or compound containing a heavy metal selected from the group consisting of arsenic, beryllium, lead, cadmium, chromium, nickel, zinc, mercury, and barium.

42. A process as recited in claim 41 wherein said at least one heavy metal is mercury.

43. A process as recited in claim 37 wherein said vanadium-phosphorus-oxide material further comprises from about 1-20% by weight silicon.

44. A process as recited in claim 37 wherein step (b) results in a pressure drop in said off gas stream of less than about 20 psia.

45. A process as recited in claim 37 wherein said off gas stream has a temperature between about 50-400° F. during step (b).

46. A process as recited in claim 37 wherein said vanadium-phosphorus-oxide material comprises finely divided particles that are suspended in said off gas stream during step (b).

47. A process as recited in claim 37 wherein step (b) results in the sorption of at least about 80% by weight of said at least one heavy metal contained in said gas stream.

48. A process as recited in claim 37 wherein step (a) results in the removal of at least about 90% by weight of said at least one heavy metal compound from said flue gas stream.

49. A process as recited in claim 37 wherein said vanadium-phosphorus-oxide material comprises from about 5-50% by weight vanadium.

50. A process as recited in claim 37 wherein said vanadium-phosphorus-oxide material oxidizes said heavy metal into an oxidized heavy metal species or heavy metal containing compound during step (a).
